(19) United States
(12) Patent Application Publication
(10) Pub. No.: US 2026/0158872 A1
(43) Pub. Date: Jun. 11, 2026

(54) HEAT PUMP SYSTEM FOR A VEHICLE

(71) Applicants: HYUNDAI MOTOR COMPANY, Seoul (KR); KIA CORPORATION, Seoul (KR); DOOWON CLIMATE CONTROL CO., LTD., Asan-si (KR)

(72) Inventors: Jeawan Kim, Hwaseong-si (KR); Hochan An, Hwaseong-si (KR); Yeon Ho Kim, Hwaseong-si (KR); Gwi Taek Kim, Hwaseong-si (KR); Hoyoung Jeong, Hwaseong-si (KR); Yeong Jun Kim, Hwaseong-si (KR); Jae Yeon Kim, Hwaseong-si (KR); Man Hee Park, Hwaseong-si (KR); Won Suk Lee, Asan-si (KR); Tae Min Park, Asan-si (KR); Soon-Jong Lee, Asan-si (KR)

(73) Assignees: HYUNDAI MOTOR COMPANY, Seoul (KR); KIA CORPORATION, Seoul (KR); DOOWON CLIMATE CONTROL CO., LTD., Asan-si (KR)

(21) Appl. No.: 19/242,483

(22) Filed: Jun. 18, 2025

(30) Foreign Application Priority Data
Dec. 6, 2024 (KR) 10-2024-0181001

(51) Int. Cl. B60H 1/32; B60H 1/00

(52) U.S. Cl. CPC B60H 1/3228; B60H 1/00278; B60H 1/3207; B60H 2001/3286

(57) ABSTRACT

A heat pump system for a vehicle improves the overall cooling performance and efficiency of a vehicle by heating the vehicle interior by using a high-temperature coolant. Additionally, the heat pump system further employs a separate condenser for subcooling the refrigerant by using the coolant supplied from a dedicated radiator.

### CROSS-REFERENCE TO RELATED APPLICATION

This application claims priority to and the benefit of Korean Patent Application No. 10-2024-0181001, filed with the Korean Intellectual Property Office on Dec. 6, 2024, the entire contents of which is incorporated herein by reference.

### BACKGROUND

### Technical Field

The present disclosure relates to a heat pump system for a vehicle, and more particularly, the present disclosure relates to a heat pump system for a vehicle capable of improving the cooling performance and efficiency.

### Description of the Related Art

An air conditioning system for a vehicle includes an air conditioner unit circulating a refrigerant in order to heat or cool an interior of a vehicle.

The air conditioner unit, which is to maintain the interior of the vehicle at an appropriate temperature regardless of a change in an external temperature to maintain a comfortable interior environment, is configured to heat or cool the interior of a vehicle by exchanging heat by a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in the summer.

In accordance with a continuous increase in interest in energy efficiency and an environmental pollution problem, the development of an environment-friendly vehicle capable of substantially substituting for an internal combustion engine vehicle is required, and the environment-friendly vehicle is classified into an electric vehicle driven using a fuel cell or electricity as a power source and a hybrid vehicle driven using an engine and a battery.

In the electric vehicle or the hybrid vehicle among these environment-friendly vehicles, a separate heater is not used unlike an air conditioner of a general vehicle, and an air conditioner used in the environment-friendly vehicle is generally called a heat pump system.

The electric vehicle driven by the power source of the fuel cell generates driving force by converting chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, a hybrid vehicle generates driving force by driving a motor using electricity supplied from the fuel cell described above or an electrical battery, together with an engine operated by a general fuel. Therefore, heat generated from the fuel cell or the battery and the motor should be effectively removed in order to secure performance of the motor.

Therefore, in a hybrid vehicle or an electric vehicle according to the related art, a cooling apparatus, a heat pump system, and a battery cooling apparatus, respectively, should be configured as separate closed circuits so as to prevent heat generation of the motor, an electric component, and the battery including a fuel cell.

Therefore, there is a disadvantage in that the layout of the connecting pipes supplying refrigerant or coolant to the heat pump system, cooling apparatus, and battery cooling apparatus inside the engine compartment becomes complicated.

In addition, since a battery cooling apparatus for heating or cooling the battery according to a state of the vehicle is separately provided to obtain an optimal performance of the battery, a plurality of valves for selectively interconnecting connections pipes are employed, and thus noise and vibration due to frequent opening and closing operations of the valves may be introduced into the vehicle interior, thereby deteriorating the ride comfort.

In conventional heat pump systems, a separate air-cooled condenser is applied to increase the condensation rate of the refrigerant, but there is also a disadvantage in that the size and weight of the cooling module disposed at the front of the vehicle excessively increase, and the overall manufacturing cost increases.

In addition, since a separate heat-exchanger should be employed in order to recollect the waste heat from various heat sources in the heating mode of the vehicle, there is also the disadvantage of increasing the manufacturing cost.

The above information disclosed in this Background section is only for enhancement of understanding of the background of the disclosure, and therefore it may contain information that does not form the prior art that is already known to a person having ordinary skill in the art.

### SUMMARY

The present disclosure provides a heat pump system for a vehicle capable of improving the overall cooling performance and efficiency by heating the vehicle interior by using a high-temperature coolant, and additionally employing a separate condenser for subcooling the refrigerant by using the coolant supplied from a dedicated radiator.

According to an embodiment of the present disclosure, a heat pump system for a vehicle includes: a compressor configured to compress a refrigerant; a Heating, Ventilation, and Air Conditioning (HVAC) module including a heater core and an evaporator connected to the compressor through a refrigerant line, and a door configured to open and close to adjust air having passed through the evaporator to be selectively introduced into the heater core when cooling or heating of a vehicle interior. The heat pump system further includes a condenser connected to the compressor through the refrigerant line, and configured to condense the refrigerant. The heat pump system further includes a sub-condenser connected to the condenser through the refrigerant line, and configured to selectively condense the refrigerant discharged from the condenser. The heat pump system further includes a first expansion valve disposed between and connected to the sub-condenser and the evaporator through the refrigerant line. The heat pump system further includes a refrigerant connection line having a first end connected to the refrigerant line between the sub-condenser and the first expansion valve, and a second end connected to the refrigerant line between the evaporator and the compressor. The heat pump system further includes a chiller provided on the refrigerant connection line. The heat pump system further includes a first cooling apparatus connected to the condenser through a first coolant line, and including a first radiator, an electrical component, and a first water pump provided on the first coolant line so as to allow the first coolant to flow along the first coolant line. The first heat pump system further includes a second cooling apparatus connected to the sub-condenser through a second coolant line, and including a second radiator, and a second water pump provided on the second coolant line so as to allow the second coolant to flow along the second coolant line.

The first cooling apparatus may be connected to the chiller through a coolant connection line connected to the first coolant line so that the first coolant is selectively supplied to the chiller.

The heat pump system may further include a second expansion valve provided on the refrigerant connection line at an upstream end of the chiller, a battery module connected to the chiller through a third coolant line, and the heater core may be connected to the condenser through a fourth coolant line.

In a cooling mode of the vehicle interior, the refrigerant line interconnecting the compressor, the condenser, the sub-condenser, the first expansion valve, and the evaporator may be opened. The first coolant line may be opened so that the first coolant is supplied from the first cooling apparatus to the condenser. The second coolant line may be opened so that the second coolant is supplied from the second cooling apparatus to the sub-condenser. The coolant connection line may be closed. The fourth coolant line may be closed. The first expansion valve may expand the refrigerant introduced through the refrigerant line and may supply the expanded refrigerant to the evaporator.

The sub-condenser may additionally condense the refrigerant condensed at the condenser while exchanging heat between the second coolant supplied from the second cooling apparatus through the second coolant line with the refrigerant supplied from the condenser.

When cooling of the battery module is required in the cooling mode of the vehicle interior, the refrigerant connection line may be opened by the second expansion valve, the third coolant line may be opened, the second expansion valve may expand the refrigerant introduced through the refrigerant connection line and may supply the expanded refrigerant to the chiller.

In a heating mode of the vehicle interior, a portion of the refrigerant line interconnecting the compressor, the condenser, and the sub-condenser may be opened. A portion of the refrigerant line connecting the sub-condenser and a first end of the refrigerant connection line may be opened. A portion of the refrigerant line connecting the first end of the refrigerant connection line to a second end of the refrigerant connection line via the first expansion valve and the evaporator may be closed by the first expansion valve. The refrigerant connection line may be opened by the second expansion valve. A portion of the first coolant line and the coolant connection line may be opened so that the first coolant is supplied from the first cooling apparatus to the chiller. A remaining first coolant line connected to the condenser may be closed. The second coolant line may be closed so that the second coolant may not be supplied from the second cooling apparatus to the sub-condenser. The fourth coolant line may be opened. The first expansion valve may stop operating. The second expansion valve may expand the refrigerant introduced through the refrigerant connection line and may supply the expanded refrigerant to the chiller.

The chiller may evaporate the refrigerant while exchanging heat between the first coolant supplied from the first cooling apparatus through the first coolant line and the refrigerant, and may supply the evaporated refrigerant to the compressor.

In a heating and dehumidifying mode of the vehicle interior, the refrigerant line interconnecting the compressor, the condenser, the sub-condenser, the first expansion valve, and the evaporator may be opened. The refrigerant connection line may be opened by the second expansion valve. A portion of the first coolant line and the coolant connection line may be opened so that the first coolant is supplied from the first cooling apparatus to the chiller. A remaining first coolant line connected to the condenser may be closed. The second coolant line may be closed so that the second coolant may not be supplied from the second cooling apparatus to the sub-condenser. The fourth coolant line may be opened. The first expansion valve may expand the refrigerant introduced through the refrigerant line and may supply the expanded refrigerant to the evaporator. The second expansion valve may expand the refrigerant introduced through the refrigerant connection line and may supply the expanded refrigerant to the chiller.

When a waste heat of the battery module is to be recollected in a heating mode of the vehicle interior or a heating and dehumidifying mode of the vehicle interior, the third coolant line may be opened.

In a heating mode of the vehicle interior or a heating and dehumidifying mode of the vehicle interior, the chiller may recollect at least one of an ambient air heat or a waste heat of the electrical component while exchanging heat between the first coolant supplied through the coolant connection line and the refrigerant.

The first expansion valve and the second expansion valve may be electronic expansion valves configured to selectively expand the refrigerant while controlling the flow of the supplied refrigerant.

The coolant connection line may be connected to the first coolant line through a control valve provided on the first coolant line between the electrical component and the condenser.

The heat pump system may further include a receiver dryer provided on the refrigerant line between the condenser and the sub-condenser.

The condenser, the sub-condenser, and the chiller may be water-cooled heat-exchangers.

As described above, according to a heat pump system for a vehicle according to an embodiment of the present disclosure, by heating the vehicle interior by using a high-temperature coolant, and additionally employing a separate condenser for subcooling the refrigerant by using the coolant supplied from a dedicated radiator, the overall cooling performance and efficiency may be improved.

In addition, according to the present disclosure, the thermal energy generated from the refrigerant when condensing the refrigerant may be selectively heat-exchanged with the coolant, and the vehicle interior may be more efficiently heated by using the heat-exchanged high-temperature coolant.

In addition, according to the present disclosure, by selectively using the ambient air heat, the waste heat of the electrical component, and the waste heat of the battery module when heating the vehicle interior, the heating efficiency of the vehicle may be improved, and by efficiently adjusting the temperature of the battery module so that the optimal performance of the battery module may be achieved, the overall travel distance of the vehicle may be increased.

In addition, according to the present disclosure, due to streamlining of the entire system, it is possible to reduce the overall manufacturing cost and weight, and improve space utilization by minimizing the number of components.

### BRIEF DESCRIPTION OF THE DRAWINGS

FIG. 1 is a block diagram illustrating a heat pump system for a vehicle according to an embodiment of the present disclosure.

FIG. 2 is an operation diagram according to a cooling mode of a vehicle interior in a heat pump system for a vehicle according to an embodiment of the

### Present Disclosure.

FIG. 3 is an operation diagram according to a heating mode of a vehicle interior in a heat pump system for a vehicle according to an embodiment of the present disclosure.

FIG. 4 is an operation diagram according to a heating-and-dehumidifying mode of the vehicle interior in a heat pump system for a vehicle according to an embodiment of the present disclosure.

### DETAILED DESCRIPTION

Some embodiments of the present disclosure are hereinafter described in detail with reference to the accompanying drawings.

Embodiments disclosed in the present specification and the constructions depicted in the drawings are only example embodiments of the present disclosure, and do not cover the entire scope of the present disclosure. Therefore, it should be understood that there may be various equivalents and variations at the time of the application of this specification.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, are exaggerated for clarity.

In addition, unless explicitly described to the contrary, the words “comprise”, “have”, “include” and variations thereof such as “comprises” or “comprising”, should be understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

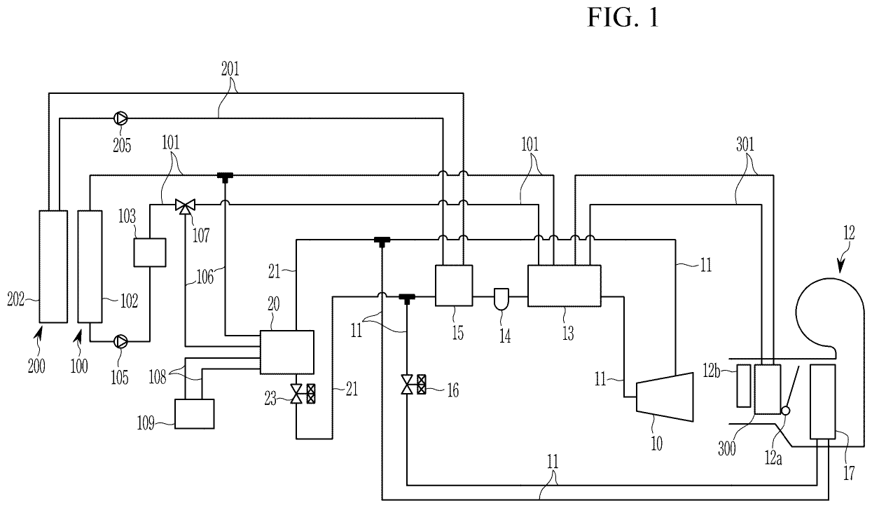

FIG. 1 is a block diagram illustrating a heat pump system for a vehicle according to an embodiment of the present disclosure.

A heat pump system for the vehicle according to an embodiment of the present disclosure may improve the overall cooling performance and efficiency, by heating a vehicle interior by using a high-temperature coolant, and by additionally employing a separate sub-condenser 15 configured to subcool a refrigerant by using the coolant supplied from a dedicated radiator.

Referring to FIG. 1, the heat pump system may include a compressor 10, a heating, ventilation, and air-conditioning (HVAC) module 12, a condenser 13, the sub-condenser 15, a first expansion valve 16, an evaporator 17, a chiller 20, a refrigerant connection line 21, and a second expansion valve 23, through which the refrigerant circulates.

In addition, the heat pump system may further include a first cooling apparatus 100 in which the first coolant circulates, and a second cooling apparatus 200 in which the second coolant circulates.

The compressor 10 may compress the introduced refrigerant and allow the compressed refrigerant to flow along a refrigerant line 11 so that the refrigerant circulates along the refrigerant line 11.

In an embodiment of the present disclosure, the HVAC module 12 may be internally provided with the evaporator 17 connected through the refrigerant line 11, and a heater core 300 to which the high-temperature coolant is selectively supplied.

A door 12a may be provided inside an interior of the HVAC module 12 between the evaporator 17 and the heater core 300. The door 12a is configured to open and close to adjust or regulate ambient air having passed through the evaporator 17 to be selectively introduced into the heater core 300.

When heating the vehicle interior, the door 12a may be opened so that the ambient air having passed through the evaporator 17 is introduced into the heater core 300.

In other words, the high-temperature coolant supplied to the heater core 300 may increase the temperature of the ambient air passing through the heater core 300. In other words, the introduced ambient air may be converted into a high-temperature state while passing through the heater core 300 and then introduced into the vehicle interior, thereby implementing heating of the vehicle interior.

At the time of cooling the vehicle interior, the door 12a may close a side toward the heater core 300 so that the ambient air cooled while passing through the evaporator 17 is directly introduced into the vehicle interior.

Accordingly, the ambient air passing through the evaporator 17 may be cooled while passing through the evaporator 17 by a low-temperature refrigerant supplied to the evaporator 17. The cooled ambient air may be introduced into the vehicle interior, thereby cooling the vehicle interior.

The HVAC module 12 may further include an air heater 12b. The air heater 12b may be disposed inside the HVAC module 12 and on a downstream side of the heater core 300 toward the vehicle interior, so as to selectively heat the ambient air having passed through the heater core 300.

The downstream side of the heater core 300 may be set based on the flow direction of the ambient air.

In other words, based on the direction in which the ambient air flows in the HVAC module 12, the location where the ambient air is introduced into the heater core 300 may be defined as an upstream side of the heater core 300, and the location where the ambient air is discharged from the heater core 300 may be defined as a downstream side of the heater core 300.

In an embodiment of the present disclosure, the condenser 13 may be connected to the compressor 10 through the refrigerant line 11.

The first cooling apparatus 100 may be connected to the condenser 13 through a first coolant line 101. The first cooling apparatus 100 may allow the first coolant to flow along the first coolant line 101.

The first cooling apparatus 100 may include a first radiator 102, an electrical component 103, and a first water pump 105 provided on the first coolant line 101.

The first radiator 102 may be disposed at the front of the vehicle. A cooling fan (not shown) may be provided on a downstream side of the first radiator 102. Accordingly, the first radiator 102 may cool the first coolant through an operation of the cooling fan and heat-exchange with the ambient air.

The electrical component may include an electrical power control apparatus, an inverter, an on-board charger (OBC), an autonomous driving controller, or the like.

The first cooling apparatus 100 configured as such may supply the first coolant cooled at the first radiator 102 to the electrical component 103. In addition, the first cooling apparatus 100 may supply the first coolant to the condenser 13 through the first coolant line 101.

In other words, the first coolant may circulate along the first coolant line 101 according to an operation of the first water pump 105.

Accordingly, the condenser 13 may condense the refrigerant by using the first coolant supplied from the first cooling apparatus 100 through the first coolant line 101.

The condenser 13 may recollect a waste heat of the electrical component 103 while exchanging heat between the first coolant introduced from the first cooling apparatus 100 and the refrigerant, or may cool the electrical component 103 by using the first coolant heat-exchanged with the refrigerant.

The condenser 13 configured as such may be a water-cooled heat-exchanger into which the first coolant is introduced.

In an embodiment of the present disclosure, the sub-condenser 15 may be connected to the condenser 13 through the refrigerant line 11. The sub-condenser 15 may selectively condense the refrigerant discharged from the condenser 13.

The second cooling apparatus 200 may be connected to the sub-condenser 15 through a second coolant line 201. The second cooling apparatus 200 may allow the second coolant to flow along the second coolant line 201.

The second cooling apparatus 200 may include a second radiator 202 and a second water pump 205 provided on the second coolant line 201.

The second radiator 202 may be disposed in front of the first radiator 102 based on a front-rear direction of the vehicle. Accordingly, the second radiator 202 may cool the second coolant through the operation of the cooling fan and heat-exchange with the ambient air.

The second cooling apparatus 200 configured as such may supply the second coolant cooled at the second radiator 202 to the sub-condenser 15 through the second coolant line 201.

The second coolant may circulate along the second coolant line 201 according to an operation of the second water pump 205.

Accordingly, the sub-condenser 15 may additionally condense the refrigerant by using the second coolant selectively supplied from the second cooling apparatus 200 through the second coolant line 201.

In other words, the sub-condenser 15 may heat-exchange the introduced refrigerant with the second coolant, so as to further lower the temperature of the refrigerant, and further increase the condensation degree of the refrigerant.

Therefore, the sub-condenser 15 may additionally condense the refrigerant condensed at the condenser 13, so as to increase the sub-cooling of the refrigerant. Accordingly, the coefficient of performance (COP), which is a coefficient of cooling capability compared to a required compressor power may be improved.

The sub-condenser 15 configured as such may be a water-cooled heat-exchanger into which the second coolant is introduced.

In an embodiment of the present disclosure, a receiver dryer 14 may be provided on the refrigerant line 11 between the condenser 13 and the sub-condenser 15.

The receiver dryer 14 may separate the gaseous refrigerant remaining in the liquid refrigerant condensed at the condenser 13.

In other words, the receiver dryer 14 may separate a gas component from the introduced refrigerant, and may filter out moisture and foreign substances, to discharge only the liquid refrigerant to the sub-condenser 15.

In an embodiment of the present disclosure, the first expansion valve 16 may be provided on the refrigerant line 11 connecting the sub-condenser 15 and the evaporator 17. The first expansion valve 16 may selectively expand the introduced refrigerant.

The first expansion valve 16 may be an electronic expansion valve configured to selectively expand the refrigerant while controlling the flow of the refrigerant supplied through the refrigerant line 11.

The evaporator 17 may be provided on the refrigerant line 11 between the first expansion valve 16 and the compressor 10. As described above, the evaporator 17 may be provided inside the HVAC module 12.

The evaporator 17 configured as such may evaporate the refrigerant supplied from the first expansion valve 16 through exchanging heat with the ambient air.

In addition, the chiller 20 may be provided on the refrigerant connection lie 21.

A first end of the refrigerant connection line 21 may be connected to the refrigerant line between the sub-condenser 15 and the first expansion valve 16. A second end of the refrigerant connection line 21 may be connected to the refrigerant line 11 between the evaporator 17 and the compressor 10.

In addition, the second expansion valve 23 may be provided on the refrigerant connection line 21 at an upstream end of the chiller 20.

The second expansion valve 23 may be an electronic expansion valve configured to selectively expand the refrigerant while controlling the flow of the supplied refrigerant.

The second expansion valve 23 may be disposed at the upstream end of the chiller 20 so that the chiller 20 may be introduced before being supplied to the refrigerant.

In other words, the upstream end of the chiller 20 may be set based on the flow direction of the refrigerant. Based on the direction in which the refrigerant flows along the refrigerant connection line 21, the location where the refrigerant is introduced into the chiller 20 may be defined as an upstream end of the chiller 20, and the location where the refrigerant is discharged from the chiller 20 may be defined as a downstream end of the chiller 20.

The first cooling apparatus 100 may be connected to the chiller 20 through a coolant connection line 106 connected to the first coolant line 101 so that the first coolant is selectively supplied to the chiller 20.

The coolant connection line 106 may be connected to the first coolant line 101 through a control valve 107 provided on the first coolant line 101 between the electrical component 103 and the condenser 13. Accordingly, the coolant connection line 106 may be selectively opened and closed by the control valve 107.

In addition, the chiller 20 may be connected to a battery module 109 through a third coolant line 108. A water pump (not shown) may be provided on the third coolant line 108.

In other words, the coolant flowing through the third coolant line 108 may selectively flow by an operation of the water pump.

Although not shown in the drawings, the third coolant line 108 may be connected to the first cooling apparatus 100 through a separate line and valve or the like through which the first coolant flows. In other words, the first coolant may flow through the third coolant line 108.

Accordingly, the chiller 20 may exchange heat between the first coolant selectively introduced through at least one of the coolant connection line 106 or the third coolant line 108 with the selectively supplied refrigerant, to adjust the temperature of the first coolant, and to evaporate the refrigerant.

The chiller 20 may be a water-cooled heat-exchanger configured to heat-exchange the interiorly introduced refrigerant with the first coolant.

In other words, the chiller 20 may exchange heat between the second coolant introduced through the third coolant line 108 from the battery module 109 with the refrigerant, to recollect the waste heat of the battery module 109, or may cool the battery module 109 by using the second coolant heat-exchanged with the refrigerant.

In addition, in a heating mode of the vehicle interior or a heating and dehumidifying mode of the vehicle interior, the chiller 20 may recollect at least one of an ambient air heat or the waste heat of the electrical component 103 while exchanging heat between the first coolant supplied through the coolant connection line 106 with the refrigerant.

In addition, when the waste heat of the battery module 109 is to be recollected in the heating mode of the vehicle interior or the heating and dehumidifying mode of the vehicle interior, the third coolant line 108 may be opened.

In an embodiment of the present disclosure, the heater core 300 may be connected to the condenser 13 through a fourth coolant line 301. The heater core 300 may allow the coolant to selectively flow along the fourth coolant line 301.

A water pump (not shown) may be provided on the fourth coolant line 301. Accordingly, the coolant flowing through the fourth coolant line 301 may selectively flow by the operation of the water pump.

Although not shown in the drawings, the fourth coolant line 301 may be connected to the first cooling apparatus 100 through a separate line and valve or the like through which the first coolant flows. In other words, the first coolant may flow through the fourth coolant line 301.

Accordingly, in the heating mode of the vehicle interior, the condenser 13 may exchange heat between the first coolant flowing along the fourth coolant line 301 with a high-temperature refrigerant supplied from the compressor 10 to condense the refrigerant, and to increase the temperature of the first coolant.

The first coolant having its temperature increased while passing through the condenser 13 may be supplied to the heater core 300 along the fourth coolant line 301, thereby heating the vehicle interior.

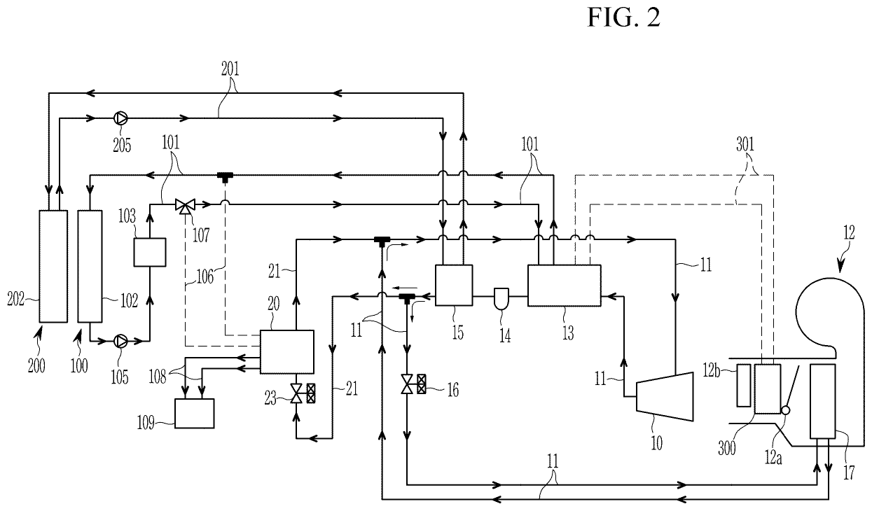

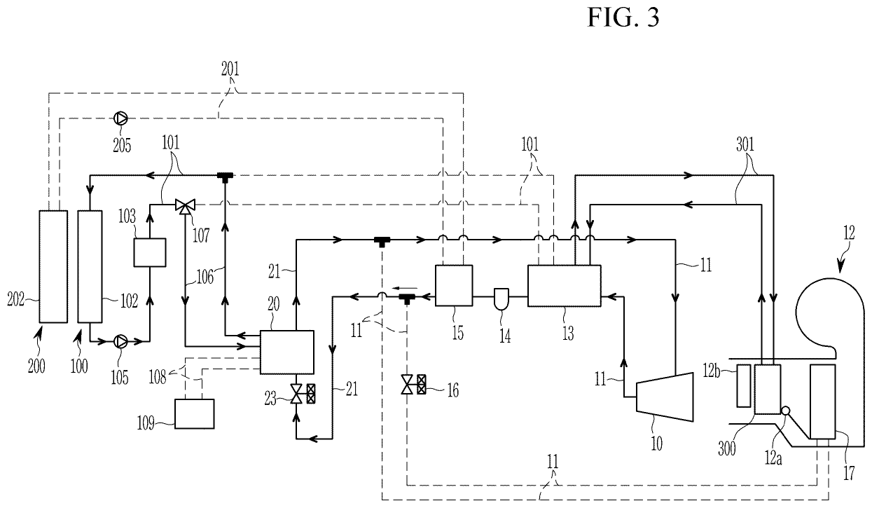

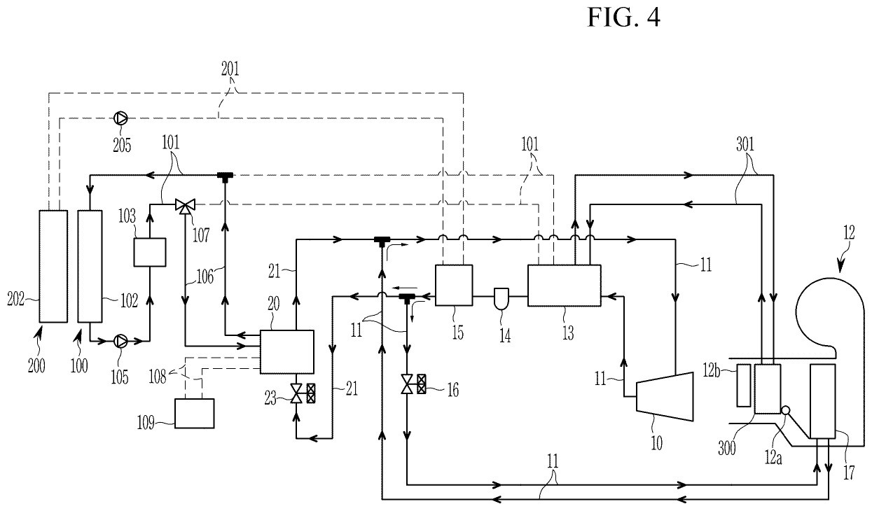

Hereinafter, an operation and action of a heat pump system for the vehicle according to an embodiment of the present disclosure configured as described above are described in detail with reference to FIG. 2 to FIG. 4.

First, an operation in a cooling mode of the vehicle interior is described with reference to FIG. 2.

FIG. 2 is an operation diagram of a heat pump system for the vehicle according to an embodiment of the present disclosure, for the cooling mode of the vehicle interior.

Referring to FIG. 2, in the cooling mode of the vehicle interior, the refrigerant line 11 interconnecting the compressor 10, the condenser 13, the receiver dryer 14, the sub-condenser 15, the first expansion valve 16, and the evaporator 17 may be opened.

The first coolant line 101 may be opened so that the first coolant is supplied from the first cooling apparatus 100 to the condenser 13.

The coolant connection line 106 may be closed by the control valve 107.

The second coolant line 201 may be opened so that the second coolant is supplied from the second cooling apparatus 200 to the sub-condenser 15.

In addition, the fourth coolant line 301 may be closed. Accordingly, the first coolant may not be supplied to the heater core 300.

In such a state, the refrigerant compressed at the compressor 10 may be introduced into the condenser 13 along the refrigerant line 11.

The condenser 13 may condense the refrigerant by using the first coolant supplied from the first cooling apparatus 100 through the first coolant line 101.

The refrigerant condensed at the condenser 13 may be introduced into the receiver dryer 14 along the refrigerant line 11.

The receiver dryer 14 may separate a gas component from the introduced refrigerant, and may filter moisture and foreign substances to discharge only the liquid refrigerant. The refrigerant discharged from the receiver dryer 14 may be supplied to the sub-condenser 15 along the refrigerant line 11.

The sub-condenser 15 may additionally condense the supplied refrigerant by using the second coolant supplied from the second cooling apparatus 200 through the second coolant line 201.

The sub-condenser 15 may additionally condense the refrigerant condensed at the condenser 13 while exchanging heat between the second coolant supplied from the second cooling apparatus 200 through the second coolant line 201 with the refrigerant supplied from the condenser 13.

The refrigerant additionally condensed at the sub-condenser 15 may be introduced into the first expansion valve 16 along the refrigerant line 11.

The first expansion valve 16 may expand the refrigerant introduced through the refrigerant line 11 and supply the expanded refrigerant to the evaporator 17.

In such a state, the ambient air introduced into the HVAC module 12 may be cooled by the low-temperature refrigerant introduced into the evaporator 17 while passing through the evaporator 17.

The door 12a may close a portion heading to the heater core 300 so that the cooled ambient air does not pass through the heater core 300. Therefore, the cooled ambient air may cool the vehicle interior by being directly introduced into the vehicle interior.

The refrigerant having its condensation degree increased while sequentially passing through the condenser 13 and the sub-condenser 15 is expanded and supplied to the evaporator 17, thereby evaporating the refrigerant to a lower temperature.

In other words, in an embodiment of the present disclosure, the condenser 13 may condense the refrigerant, and the sub-condenser 15 condenses the refrigerant, thereby providing an advantage in forming sub-cooling of the refrigerant.

In addition, as the subcooled refrigerant is evaporated at a further lower temperature in the evaporator 17, the temperature of the ambient air passing through the evaporator 17 may be further lowered, thereby improving the cooling performance and efficiency.

The refrigerant having passed through the evaporator 17 may be introduced into the compressor 10 along the refrigerant line 11.

When cooling of the battery module 109 is required in the cooling mode of the vehicle interior, the refrigerant connection line 21 may be opened by the second expansion valve 23.

In addition, the third coolant line 108 may be opened.

Accordingly, a partial refrigerant among the refrigerant additionally condensed at the sub-condenser 15 may be introduced into the first expansion valve 16 along the refrigerant line 11. At the same time, a remaining refrigerant among the refrigerant condensed at the sub-condenser 15 may be introduced into the second expansion valve 23 along the refrigerant connection line 21.

The second expansion valve 23 may expand the refrigerant introduced through the refrigerant connection line 21 and supply the expanded refrigerant to the chiller 20.

The refrigerant introduced into the chiller 20 may cool the first coolant flowing along the third coolant line 108 while exchanging heat with the first coolant supplied from the battery module 109 through the third coolant line 108.

The first coolant cooled at the chiller 20 may be supplied to the battery module 109 along the third coolant line 108. In other words, the chiller 20 may supply the first coolant cooled through heat-exchange with the refrigerant to the battery module 109 through the third coolant line 108.

Accordingly, the battery module 109 may be efficiently cooled by the first coolant cooled at the chiller 20.

In other words, the first coolant circulating through the third coolant line 108 may efficiently cool the battery module 109 while repeatedly performing the above-described operation.

The refrigerant having passed through the chiller 20 may be introduced into the compressor 10 together with the refrigerant discharged from the evaporator 17. The introduced refrigerant may be compressed by the compressor 10.

The refrigerant compressed at the compressor 10 may be supplied to the condenser 13 along the refrigerant line 11.

The heat pump system may repeatedly perform the above-described processes.

In other words, as the refrigerant subcooled while repeatedly performing the above-described processes is evaporated at a further lower temperature in the evaporator 17, the heat pump system may further lower the temperature of the ambient air passing through the evaporator 17, thereby improving the overall cooling performance and efficiency, and efficiently cooling the vehicle interior.

When cooling of the battery module 109 is required in the cooling mode, the heat pump system may efficiently cool the battery module 109 by using the low-temperature first coolant cooled at the chiller 20.

In an embodiment of the present disclosure, an operation in the heating mode of the vehicle interior is described with reference to FIG. 3.

FIG. 3 is an operation diagram according to the heating mode of a vehicle interior in a heat pump system for a vehicle according to an embodiment of the present disclosure.

Referring to FIG. 3, in the heating mode of the vehicle interior, a portion of the refrigerant line 11 interconnecting the compressor 10, the condenser 13, the receiver dryer 14, and the sub-condenser 15 may be opened.

In addition, the portion of the refrigerant line 11 connecting the sub-condenser 15 and the first end of the refrigerant connection line 21 may be opened.

In addition, the portion of the refrigerant line 11 connecting the first end of the refrigerant connection line 21 to the first expansion valve 16 and the evaporator 17 may be closed by the first expansion valve 16.

An operation of the first expansion valve 16 may be stopped. Accordingly, the refrigerant may not be supplied to the evaporator 17.

The refrigerant connection line 21 may be opened by the second expansion valve 23.

In an embodiment of the present disclosure, a portion of the first coolant line 101 and the coolant connection line 106 may be opened, so that the first coolant is supplied from the first cooling apparatus 100 to the chiller 20.

The coolant connection line 106 may be opened by the control valve 107.

In addition, the remaining first coolant line 101 connected to the condenser 13 may be closed by the control valve 107.

Accordingly, the first coolant having passed through the first radiator 102 and the electrical component 103 may be introduced into the first radiator 102 from the first cooling apparatus 100 after passing through the chiller 20 through a portion of the first coolant line 101 and the coolant connection line 106.

In addition, the second coolant line 201 may be closed, so that the second coolant may not be supplied from the second cooling apparatus 200 to the sub-condenser 15.

In addition, the fourth coolant line 301 may be opened so that the first coolant may circulate through the condenser 13 and the heater core 300. Accordingly, the first coolant having its temperature increased through heat-exchange with the refrigerant in the condenser 13 may be supplied to the heater core 300.

In such a state, the refrigerant compressed at the compressor 10 may be introduced into the condenser 13 along the refrigerant line 11.

The condenser 13 may condense the refrigerant by using the first coolant supplied from the heater core 300 through the fourth coolant line 301.

Accordingly, the refrigerant introduced into the condenser 13 may be condensed while exchanging heat with the first coolant supplied from the heater core 300 through the fourth coolant line 301.

The first coolant having its temperature increased through exchanging heat with the refrigerant in the condenser 13 may be supplied to the heater core 300.

In other words, the condenser 13 may supply the first coolant having its temperature increased through exchanging heat with the refrigerant to the heater core 300 through the fourth coolant line 301.

In addition, the refrigerant condensed at the condenser 13 may be introduced into the receiver dryer 14 along the refrigerant line 11.

The receiver dryer 14 may separate a gas component from the introduced refrigerant, and may filter moisture and foreign substances to discharge only the liquid refrigerant. The refrigerant discharged from the receiver dryer 14 may pass through the sub-condenser 15 along the refrigerant line 11.

The refrigerant having passed through the sub-condenser 15 may be introduced into the second expansion valve 23 along the refrigerant connection line 21.

The second expansion valve 23 may expand the refrigerant introduced through the refrigerant connection line 21 and supply the expanded refrigerant to the chiller 20.

The refrigerant introduced into the chiller 20 may cool the first coolant while exchanging heat with the first coolant supplied from the first cooling apparatus 100 through the coolant connection line 106.

The first coolant may have its temperature increased by recollecting the ambient air heat and the waste heat of the electrical component 103 while passing through the first radiator 102 and the electrical component 103.

The first coolant having its temperature increased through such an operation may be supplied to the chiller 20 along a portion of the first coolant line 101 and the coolant connection line 106.

The chiller 20 may efficiently recollect the ambient air heat and the waste heat of the electrical component 103 while exchanging heat with the first coolant supplied from the first cooling apparatus 100 through the coolant connection line 106 and the refrigerant.

The chiller 20 may evaporate the refrigerant while exchanging heat between the supplied first coolant with the refrigerant.

The refrigerant evaporated at the chiller 20 may be introduced into the compressor 10 along the refrigerant connection line 21 and the opened refrigerant line 11.

In addition, the refrigerant compressed at the compressor 10 may be supplied to the condenser 13.

The heat pump system may repeatedly perform the above-described processes.

The door 12a may be opened so that the ambient air introduced into the HVAC module 12 and having passed through the evaporator 17 may pass through the heater core 300.

Accordingly, the ambient air introduced from the outside may be introduced at a room-temperature state without being cooled, when pass through the evaporator 17 that is not supplied with the refrigerant. The introduced ambient air may be converted into a high-temperature state while passing through the heater core 300 and then introduced into the vehicle interior, thereby implementing heating of the vehicle interior.

As such, when heating of the vehicle interior is required, the heat pump system may recollect the ambient air heat and the waste heat of the electrical component 103 at the chiller 20 and use it to increase the temperature of the refrigerant, thereby reducing the power consumption of the compressor 10, and improving the heating efficiency.

As such, since the heat pump system can sufficiently recollect and use the waste heat, the heating performance and efficiency may be improved while minimizing the usage of a separate electric heater.

An embodiment of the present disclosure takes an example in which the third coolant line 108 connected to the battery module 109 is closed in the heating mode of the vehicle interior, but is not limited thereto, and when the waste heat generated at the battery module 109 is also to be recollected, the third coolant line 108 may be opened.

In addition, an operation in the heating and dehumidifying mode of the vehicle interior is described with reference to FIG. 4.

FIG. 4 is an operation diagram according to the heating and dehumidifying mode of the vehicle interior in a heat pump system for a vehicle according to an embodiment of the present disclosure.

Referring to FIG. 4, in the heating and dehumidifying mode of the vehicle interior, the refrigerant line 11 interconnecting the compressor 10, the condenser 13, the receiver dryer 14, the sub-condenser 15, the first expansion valve 16, and the evaporator 17 may be opened.

The refrigerant connection line 21 may be opened by the second expansion valve 23.

In an embodiment of the present disclosure, a portion of the first coolant line 101 and the coolant connection line 106 may be opened, so that the first coolant is supplied from the first cooling apparatus 100 to the chiller 20.

The coolant connection line 106 may be opened by the control valve 107.

In addition, the remaining first coolant line 101 connected to the condenser 13 may be closed by the control valve 107.

Accordingly, the first coolant having passed through the first radiator 102 and the electrical component 103 may be introduced into the first radiator 102 from the first cooling apparatus 100 after passing through the chiller 20 through a portion of the first coolant line 101 and the coolant connection line 106.

In addition, the second coolant line 201 may be closed, so that the second coolant may not be supplied from the second cooling apparatus 200 to the sub-condenser 15.

In addition, the fourth coolant line 301 may be opened so that the first coolant may circulate through the condenser 13 and the heater core 300. Accordingly, the first coolant having its temperature increased through exchanging heat with the refrigerant in the condenser 13 may be supplied to the heater core 300.

In such a state, the refrigerant compressed at the compressor 10 may be introduced into the condenser 13 along the refrigerant line 11.

The condenser 13 may condense the refrigerant by using the first coolant supplied from the heater core 300 through the fourth coolant line 301.

Accordingly, the refrigerant introduced into the condenser 13 may be condensed while exchanging heat with the first coolant supplied from the heater core 300 through the fourth coolant line 301.

The first coolant having its temperature increased through exchanging heat with the refrigerant in the condenser 13 may be supplied to the heater core 300.

In other words, the condenser 13 may supply the first coolant having its temperature increased through exchanging heat with the refrigerant to the heater core 300 through the fourth coolant line 301.

In addition, the refrigerant condensed at the condenser 13 may be introduced into the receiver dryer 14 along the refrigerant line 11.

The receiver dryer 14 may separate a gas component from the introduced refrigerant, and may filter moisture and foreign substances to discharge only the liquid refrigerant. The refrigerant discharged from the receiver dryer 14 may pass through the sub-condenser 15 along the refrigerant line 11.

A partial refrigerant among the refrigerant having passed through the sub-condenser 15 may be introduced into the first expansion valve 16 along the refrigerant line 11.

The first expansion valve 16 may expand the refrigerant introduced through the refrigerant line 11 and supply the expanded refrigerant to the evaporator 17.

A remaining refrigerant among the refrigerant having passed through the sub-condenser 15 may be introduced into the second expansion valve 23 along the refrigerant connection line 21.

The second expansion valve 23 may expand the refrigerant introduced through the refrigerant connection line 21 and supply the expanded refrigerant to the chiller 20.

The refrigerant introduced into the chiller 20 may cool the first coolant while exchanging heat with the first coolant supplied from the first cooling apparatus 100 through the coolant connection line 106.

The first coolant may have its temperature increased by recollecting the ambient air heat and the waste heat of the electrical component 103 while passing through the first radiator 102 and the electrical component 103.

The first coolant having its temperature increased through such an operation may be supplied to the chiller 20 along a portion of the first coolant line 101 and the coolant connection line 106.

The chiller 20 may efficiently recollect the ambient air heat and the waste heat of the electrical component 103 while exchanging heat between the first coolant supplied from the first cooling apparatus 100 through the coolant connection line 106 with the refrigerant.

The chiller 20 may evaporate the refrigerant while exchanging heat between the supplied first coolant and the refrigerant.

The refrigerant evaporated at the chiller 20 may be introduced into the compressor 10 together with the refrigerant discharged from the evaporator 17. The introduced refrigerant may be compressed by the compressor 10.

In addition, the refrigerant compressed at the compressor 10 may be supplied to the condenser 13.

The heat pump system may repeatedly perform the above-described processes.

The door 12a may open a portion for passing through the heater core 300, so that the ambient air introduced into the HVAC module 12 and cooled while passing through the evaporator 17 may pass through the heater core 300.

Accordingly, the ambient air introduced into the vehicle interior may be dehumidified while exchanging heat with the low-temperature refrigerant supplied into the evaporator 17 by an operation of a blower-fan (not shown).

The dehumidified ambient air may be converted into a high-temperature state while passing through the heater core 300 and introduced into the vehicle interior, thereby smoothly heating and dehumidifying the vehicle interior.

An embodiment of the present disclosure takes an example in which the third coolant line 108 connected to the battery module 109 is closed in the heating and dehumidifying mode of the vehicle interior, but is not limited thereto, and when the waste heat generated at the battery module 109 is also to be recollected, the third coolant line 108 may be opened.

As described above, according to a heat pump system for a vehicle according to an embodiment of the present disclosure, by heating the vehicle interior by using the high-temperature coolant, and by additionally employing the sub-condenser 15 configured to subcool the refrigerant by using the second coolant supplied from the second radiator 202 in the second cooling apparatus 200, the overall cooling performance and efficiency may be improved.

In addition, according to the present disclosure, the thermal energy generated from the refrigerant at the time of condensing the refrigerant may be selectively heat-exchanged with the coolant, and the vehicle interior may be more efficiently heated by using the heat-exchanged high-temperature coolant.

In addition, according to the present disclosure, at the time of heating of the vehicle interior, by selectively using the ambient air heat, the waste heat of the electrical component 103, and the waste heat of the battery module 109, the heating efficiency of the vehicle may be improved, and by efficiently adjusting the temperature of the battery module 109 to achieve the optimal performance of the battery module 109, the overall travel distance of the vehicle may be increased.

In addition, according to the present disclosure, due to streamlining of the entire system, it is possible to reduce the overall manufacturing cost and weight, and improve space utilization by minimizing the number of components.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

10: compressor
11: refrigerant line
12: HVAC module
12a: door
12b: air heater
13: condenser
14: receiver dryer 15: sub-condenser
16: first expansion valve
17: evaporator
20: chiller
21: refrigerant connection line
23: second expansion valve
100: first cooling apparatus
101: first coolant line
102: first radiator
103: electrical component
105: first water pump
106: coolant connection line
107: control valve
108: third coolant line
109: battery module
200: second cooling apparatus
201: second coolant line
202: second radiator
205: second water pump
300: heater core
301: fourth coolant line

What is claimed is:

1. A heat pump system for a vehicle, the heat pump system comprising:
a compressor configured to compress a refrigerant;
a Heating, Ventilation, and Air Conditioning (HVAC) module including a heater core and an evaporator connected to the compressor through a refrigerant line, and including a door configured to open and close to adjust an air having passed through the evaporator to be selectively introduced into the heater core when cooling or heating a vehicle interior;
a condenser connected to the compressor through the refrigerant line, the condenser configured to condense the refrigerant;
a sub-condenser connected to the condenser through the refrigerant line, the sub-condenser configured to selectively condense the refrigerant discharged from the condenser;
a first expansion valve disposed between and connected to the sub-condenser and the evaporator through the refrigerant line;
a refrigerant connection line including a first end connected to the refrigerant line between the sub-condenser and the first expansion valve, and a second end connected to the refrigerant line between the evaporator and the compressor;
a chiller provided on the refrigerant connection line;
a first cooling apparatus connected to the condenser through a first coolant line, wherein the first cooling apparatus includes a first radiator, an electrical component, and a first water pump provided on the first coolant line to allow a first coolant to flow along the first coolant line; and
a second cooling apparatus connected to the sub-condenser through a second coolant line, wherein the second cooling apparatus includes a second radiator and a second water pump provided on the second coolant line to allow a second coolant to flow along the second coolant line.

2. The heat pump system of claim 1, wherein the first cooling apparatus is connected to the chiller through a coolant connection line connected to the first coolant line so that the first coolant is selectively supplied to the chiller.

3. The heat pump system of claim 2, further comprising:
a second expansion valve provided on the refrigerant connection line at an upstream end of the chiller; and
a battery module connected to the chiller through a third coolant line,
wherein the heater core is connected to the condenser through a fourth coolant line.

4. The heat pump system of claim 3, wherein, in a cooling mode of the vehicle interior:
the refrigerant line interconnecting the compressor, the condenser, the sub-condenser, the first expansion valve, and the evaporator is configured to be opened;
the first coolant line is configured to be opened so that the first coolant is supplied from the first cooling apparatus to the condenser;
the second coolant line is configured to be opened so that the second coolant is supplied from the second cooling apparatus to the sub-condenser;
the coolant connection line is configured to be closed;
the fourth coolant line is configured to be closed; and
the first expansion valve is configured to expand the refrigerant introduced through the refrigerant line and supply the refrigerant expanded by the first expansion valve to the evaporator.

5. The heat pump system of claim 4, wherein the sub-condenser is configured to condense the refrigerant condensed at the condenser while exchanging heat between the second coolant supplied from the second cooling apparatus through the second coolant line and the refrigerant supplied from the condenser.

6. The heat pump system of claim 4, wherein, when cooling of the battery module is required in the cooling mode of the vehicle interior:
the refrigerant connection line is configured to be opened by the second expansion valve;
the third coolant line is configured to be opened; and
the second expansion valve is configured to expand the refrigerant introduced through the refrigerant connection line and supply the refrigerant expanded by the second expansion valve to the chiller.

7. The heat pump system of claim 3, wherein, in a heating mode of the vehicle interior:
a portion of the refrigerant line interconnecting the compressor, the condenser, and the sub-condenser is configured to be opened;
a portion of the refrigerant line connecting the sub-condenser and the first end of the refrigerant connection line are configured to be opened;
a portion of the refrigerant line connecting the first end of the refrigerant connection line to the second end of the refrigerant connection line via the first expansion valve and the evaporator is configured to be closed by the first expansion valve;
the refrigerant connection line is configured to be opened by the second expansion valve;
a portion of the first coolant line and the coolant connection line are configured to be opened so that the first coolant is supplied from the first cooling apparatus to the chiller;
a remaining portion of the first coolant line connected to the condenser is configured to be closed;
the second coolant line is configured to be closed so that the second coolant is not supplied from the second cooling apparatus to the sub-condenser;
the fourth coolant line is configured to be opened;
the first expansion valve is configured to stop operating; and
the second expansion valve is configured to expand the refrigerant introduced through the refrigerant connection line and supply the refrigerant expanded by the second expansion valve to the chiller.

8. The heat pump system of claim 7, wherein the chiller is configured to evaporate the refrigerant while exchanging heat between the first coolant supplied from the first cooling apparatus through the first coolant line and the refrigerant, and supply the refrigerant evaporated by the chiller to the compressor.

9. The heat pump system of claim 3, wherein, in a heating and dehumidifying mode of the vehicle interior,
the refrigerant line interconnecting the compressor, the condenser, the sub-condenser, the first expansion valve, and the evaporator is configured to be opened;
the refrigerant connection line is configured to be opened by the second expansion valve;
a portion of the first coolant line and the coolant connection line are configured to be opened so that the first coolant is supplied from the first cooling apparatus to the chiller;
a remaining first coolant line connected to the condenser is configured to be closed;
the second coolant line is configured to be closed so that the second coolant is not supplied from the second cooling apparatus to the sub-condenser;
the fourth coolant line is configured to be opened;
the first expansion valve is configured to expand the refrigerant introduced through the refrigerant line and supply the refrigerant expanded by the first expansion valve to the evaporator; and
the second expansion valve is configured to expand the refrigerant introduced through the refrigerant connection line and supply the refrigerant expanded by the second expansion valve to the chiller.

10. The heat pump system of claim 3, wherein, when a waste heat of the battery module is to be recollected in a heating mode of the vehicle interior or a heating and dehumidifying mode of the vehicle interior, the third coolant line is configured to be opened.

11. The heat pump system of claim 3, wherein, in a heating mode of the vehicle interior or a heating and dehumidifying mode of the vehicle interior, the chiller recollects at least one of an ambient air heat or a waste heat of the electrical component while exchanging heat between the first coolant supplied through the coolant connection line and the refrigerant.

12. The heat pump system of claim 3, wherein the first expansion valve and the second expansion valve are electronic expansion valves configured to selectively expand the refrigerant while controlling a flow of the refrigerant.

13. The heat pump system of claim 2, wherein the coolant connection line is connected to the first coolant line through a control valve provided on the first coolant line between the electrical component and the condenser.

14. The heat pump system of claim 1, further comprising a receiver dryer provided on the refrigerant line between the condenser and the sub-condenser.

15. The heat pump system of claim 1, wherein the condenser, the sub-condenser, and the chiller are water-cooled heat-exchangers.
